(19) United States
(12) Patent Application Publication
(10) Pub. No.: US 2019/0269148 A1
(43) Pub. Date: Sep. 5, 2019

(54) DEVICE AND METHOD FOR PREPARING COOLED OR FROZEN PRODUCTS

(71) Applicant: NESTEC SA, Vevey (CH)

(72) Inventors: Youcef Ait Bouziad, Echandens (CH); Franois Texier, Cognin (FR)

(21) Appl. No.: 16/080,701

(22) PCT Filed: Mar. 9, 2017
(86) PCT No.: PCT/EP2017/055522

§ 371 Date: Aug. 29, 2018

(30) Foreign Application Priority Data
Mar. 11, 2016 (EP) 16159803.2

(51) Int. Cl. A23G 9/16; A23G 9/18

(52) U.S. Cl. CPC A23G 9/16; A23G 9/18

(57) ABSTRACT

The invention relates to a device (10) for preparing a cooled or frozen and/or foamed product, comprising:—a container (20) where a certain quantity of a fluid at ambient temperature is stored;—expelling means (109) configured to deliver a certain quantity of the fluid into a processing chamber (108) at a certain flow rate;—a processing element (101) rotatable within the processing chamber (108) and configured to mix and/or scrap and/or foam the fluid in the processing chamber;—a cooling element (105) providing a certain cooling power configured to cool at least partially the processing chamber (108) which is at least partially in contact with the fluid. The invention further relates to a container (20) comprising a certain quantity of a certain fluid at ambient temperature, configured to be used with such a device (10). Further, the invention relates to a method for preparing a cooled or frozen and/or foamed product, using a device (10), to the use of such device (10) for preparing a cooled or frozen and/or foamed product and to the use of a container (20) as described in such a device (10) for such preparation.

### FIELD OF THE INVENTION

The present invention is directed to a device for preparing cooled or frozen confectionary, which can also be aerated, such as ice cream, whipped yogurt or the like, the device comprising a preparation machine and a fluid container. The device represents a compact and fast system able to provide high quality products departing from raw fluid stored at ambient temperature in the fluid container. The present invention further relates to a method for preparing such cooled or frozen products.

### BACKGROUND OF THE INVENTION

Currently, the majority of cooled confectionary or frozen confectionary such as ice cream consumption concerns products already prepared cooled or frozen and maintained in that state for a later consumption. When these products are intended for home consumption, some drawbacks arise, such as the need to transport the products at home rapidly in order to keep them at the cold or frozen state, the need to store them in a freezer and the limited number of flavors available considering standard freezer volume. Additionally, the texture of such product is rather hard and far from the freshly made confectionary.

Whether it is intended for home consumption or for using in a business, store or the like, a solution available today is the use of a cooled confectionary or ice cream machine to produce fresh confectionary products. Thereby, although the obtained texture of the resulting product is more satisfactory, the preparation procedure by means of the known machines has several drawbacks.

In particular, all the ingredients must be mixed previously, the volume of such machines corresponds usually to five or more serving portions of the same flavor and the time necessary is about half an hour (when talking of ice-cream for example). Moreover, the ingredients necessary for the preparation come in contact with a large number of parts of the preparation machine (e.g. a stirrer, tanks, or a dispenser), which all have to be cleaned. Other alternatives imply a preparation at ambient temperature before the cooling or freezing phase in a standard freezer. Hence, they are also time consuming and require cleaning tasks.

Moreover, these known machines are very voluminous and require long preparation times. Besides, more than one serving portion has to be prepared at a time (known as batch preparation). The known machines preparing cooled or frozen confectionary in batches therefore have several limitations, as discussed, such as the volume to be processed which needs to be prepared in advance and also limiting the end product to an homogeneous one where no layering distribution (by flavor, for example) is possible. Therefore, there is a demand for increasing the convenience of the preparation of cool or frozen confectionery, in particular, using machines and systems which are more compact, being able to produce mixtures of a high quality and highly aerated with stabilized foaming, providing single-serve portions and particularly avoiding the need of cleaning afterwards.

The present invention thus aims at providing a device able to address these needs and which overcomes the drawbacks in the state of the art, providing an in-line and on-demand system delivering ice-cream or cooled or foamed products departing from a fluid raw product at ambient temperature.

### SUMMARY OF THE INVENTION

According to a first aspect, the invention refers to a device for preparing a cooled or frozen and/or foamed product, the device comprising a container where a certain quantity of a fluid at ambient temperature is stored; expelling means configured to deliver a certain quantity of the fluid into a processing chamber at a certain flow rate; at least a processing element rotatable within the processing chamber and configured to mix and/or scrap and/or foam the fluid in the processing chamber; a cooling element providing a certain cooling power configured to cool at least partially the processing chamber (108) which is at least partially in contact with the fluid.

Preferably, the speed of the expelling means in the device of the invention is calculated such that the flow rate of the fluid through the processing chamber allows that the cooling power provided by the cooling element cools the fluid to a desired temperature before the fluid leaves the processing chamber.

Also preferably, the rotational speed of the processing element in the device depends on the type of cooled or frozen and/or foamed product to prepare. The rotational speed of the processing element is typically comprised in the range of 1 to 10 rpm to prepare a cooled or chilled product, and is comprised in the range of 1000 to 3000 rpm to prepare an ice-cream product or a foamed or aerated product.

Typically, the device according to the present invention further comprises an air entry connected to the processing chamber, providing a certain air ratio into this chamber. The value of this air ratio depends on the type of product to prepare, this ratio being zero when a cooled or chilled product is prepared, the ratio being different to zero when a foamed product or an ice-cream are prepared.

Preferably, in the device according to the invention, the processing chamber connects the fluid inlet from the expelled product coming from the container and a product outlet, so that the cooled or frozen and/or foamed product is delivered continuously.

Typically, the length of the processing chamber traversed by the fluid matches the cooling element.

According to a preferred embodiment of the device of the invention, the processing chamber configures a small gap in the radial direction, to allow high shear stress induced in the fluid by the processing element.

Typically, the processing chamber is configured by an outer cylinder and an inner cylinder concentrically arranged and forming a gap between them. The gap configured between the cylinders is preferably comprised between 0.1 mm and 10 mm.

In a preferred embodiment of the device of the invention, the processing element typically comprises at least a scrapping edge designed to scrap product adhering the inner walls of the processing chamber and one or a plurality of disturbing elements inducing foaming of the fluid by rotation of the processing element in the processing chamber by couette flow effect.

Typically, the container of the device is configured as a cartridge, as a capsule or the like, comprising an inner path to allow the expelling means displace inside.

Preferably, the device of the invention is further provided with identification means comprising process parameters allowing the preparation of a cooled or frozen and/or foamed product in the said device. The process parameters are typically one or a combination of: type of product to be produced, temperature of the product delivered, flow rate of fluid in the processing chamber, rotational speed of the processing element, air ratio to incorporate in the processing chamber.

According to a second aspect, the invention refers to a container comprising a certain quantity of a certain fluid at ambient temperature, configured to be used with a device (as the one previously described.

Preferably, the container comprises one part facing cooling means in the device and configuring a processing chamber where the cooled or frozen and/or foamed product is prepared.

Typically, the container comprises an inner volume configured to cooperate with expelling means displacing inside of it in order to expel at least part of its fluid content into the processing chamber in the device.

According to still a third aspect, the invention relates to a method for preparing a cooled or frozen and/or foamed product, the method comprising:
inserting a container comprising a fluid at ambient temperature into a device;
displacing expelling means to deliver at least part of the fluid content of the container into a processing chamber at a certain flow rate, depending on the type of final product to deliver;
rotating processing means at a certain speed depending on the type of product to be finally delivered within the processing chamber and simultaneously cooling at least part of the processing chamber which is at least partly in contact with the product.

Preferably, in the method of the invention, the rotational speed of the processing element varies depending on the product to be prepared, from a low speed in the range of 1 to 10 rpm to prepare a cooled or chilled product to a high speed in the range of 1000 to 3000 rpm to prepare an ice-cream product or a foamed or aerated product.

Typically, in the method of the invention, air is further introduced into the processing chamber when aerated product is desired.

According to still another aspect, the present invention refers to the use of a device as the one described for preparing a cooled or frozen and/or foamed product.

Yet according to still a different aspect, the invention relates to the use of a container as the one described in a device as previously disclosed, for preparing a cooled or frozen and/or foamed product.

### BRIEF DESCRIPTION OF THE DRAWINGS

Further features, advantages and objects of the present invention will become apparent for a skilled person when reading the following detailed description of non-limiting embodiments of the present invention, when taken in conjunction with the appended drawings, in which:

FIG. 1 shows a cut view of a device for preparing cooled or frozen or aerated confectionary according to the present invention, comprising a preparation machine and a fluid container.

FIG. 2 shows an exploded view of the different elements in a device for preparing cooled or frozen or aerated confectionary according to the present invention, as represented in FIG. 1.

FIG. 3 shows a schematic view of the device for preparing cooled or frozen or aerated confectionary according to the present invention, as represented in FIG. 1.

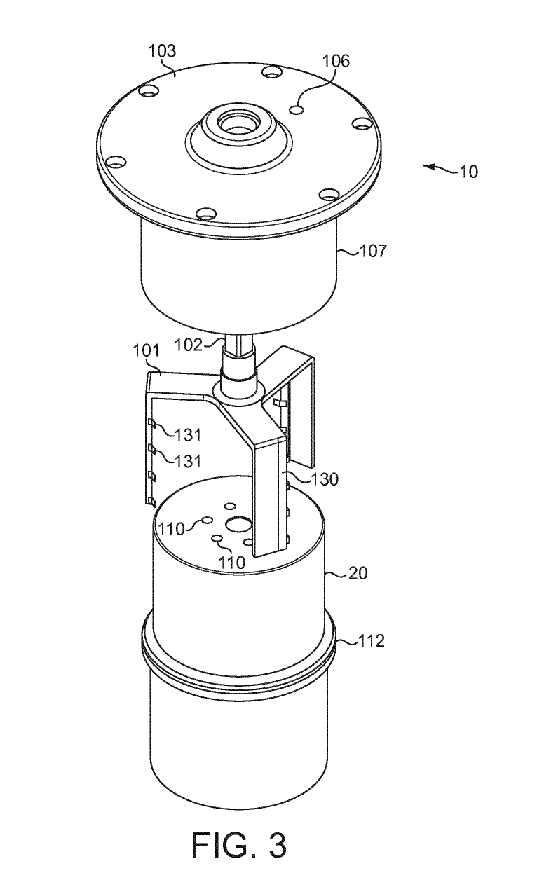

FIG. 4 shows the theoretical energy path scheme involved in the preparation of cooled confectionary using a device according to the present invention.

FIG. 5 shows the theoretical energy path scheme involved in the preparation of frozen confectionary using a device according to the present invention.

FIGS. 6a-b show schematically the basic principle of couette flow for generating shear stress.

### DETAILED DESCRIPTION OF EXEMPLARY EMBODIMENTS

According to a first aspect, the invention relates to a device 10 for preparing a cooled or frozen product, which can also be aerated. The device 10 of the invention comprises a preparation machine 100 and a container 20, the container 20 comprising raw fluid product, typically liquid, at ambient temperature, from which the final aerated or cooled or frozen product will be produced by means of the device 10. Typical products prepared by the device 10 are ice cream or whipped yogurt, for example. The device 10 works in-line providing whenever needed a portion of aerated or cooled or frozen product as desired, freshly prepared on demand departing from raw fluid at ambient temperature in the container 20.

The machine 100 comprises a processing element 101 rotating around a shaft 102, entrained in rotation by a motor (not shown): the processing element 101 typically works as a foamer and a scraper depending on its rotational speed and further on air being mixed or not with the fluid, as it will be further explained in more detail. This processing element 101 typically comprises a scrapping edge 130 designed to scrap product freezing inside cooling walls and one or a plurality of disturbing elements 131 inducing foaming of the fluid by rotation of the element 101.

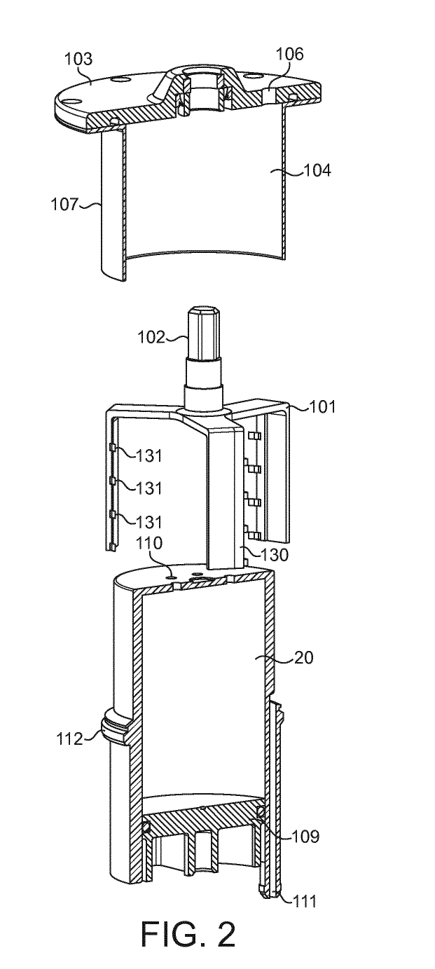

As shown in FIG. 2, for example, the machine 100 further comprises an upper cover 103 closing the upper part of the processing element 101 and connecting the shaft 102 with a motor so as to entrain in rotation the element 101. The upper cover 103 further comprises at least one air entry 106.

FIG. 2 further shows that the machine 100 comprises a processing cover element 107, arranged in such a way that, when the container 20 is introduced in the machine, there is created a processing chamber 108 between the container 20 and the processing cover element 107, of a very small thickness, into which the processing element 101 rotates. The machine 100 further comprises a cooling element 105 arranged external to the processing cover element 107, cooling the inner cooling walls 104 in contact with the fluid in the processing chamber 108.

Typically, the container 20 is cylindrically configured and so is the processing cover element 107, so the inner cooling walls 104 of the cover element 107 are complementary shaped with the external surface of the container 20.

The machine 100 is further provided with expelling means 109, typically a piston, able to displace inside the volume of the container 20 and expel from it its content. The piston is linearly actuated by a motor (not shown) in the machine 100, different to the motor entraining in rotation the processing element 101.

The container 20 of the invention comprises an internal volume where fluid is disposed and where the expelling means 109 move: fluid is expelled into the processing chamber 108 through one or a plurality of fluid outlets 110, preferably arranged on the upper surface of the container 20. The expelling means 109 are designed being very close to the inner walls of the container 20, where they move, so that most of the content of the fluid inside is expelled to the processing chamber 108. The container 20 further comprises a product outlet 111, preferably arranged vertically, connected to the processing chamber 108, so that the product content, once prepared, is delivered into a cup or appropriate recipient. The container 20 is preferably provided with stoppers 112, typically radially arranged over the container, delimiting the positioning of the processing cover element 107 so as to configure an appropriate processing chamber 108.

Preferably, the processing chamber 108 has a width in the radius direction of the container 20 (configuring an inner cylinder) and the outer cylinder (configured by the processing cover element 107 in a range of 0.1 mm to 10 mm. With these preferred values for the processing chamber width, the optimal foam properties can be achieved. For foaming to take place in the processing chamber 108, the device of the invention bases on the foaming energy being provided by high shear energy, which is achieved by passing a mixture of the fluid coming from the container 20 and air being introduced by the air entry 106 at least partly by couette flow through the processing chamber 108. It is important that the width or gap in the processing chamber 108 remains very small in order to produce high shear stress into the mixture allowing adequate foaming.

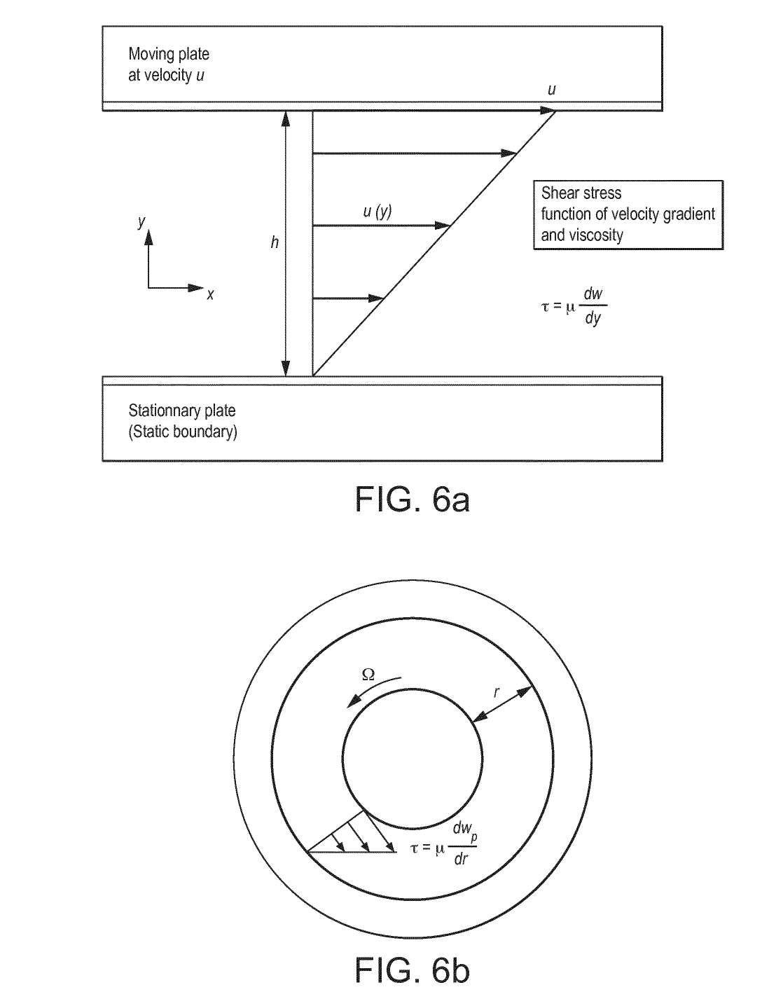

Couette flow refers to a laminar flow of a viscous fluid in a space between two parallel plates. The basic principle of Couette flow is shown in FIGS. 6a and 6b. In FIG. 6a a movable two-dimensional boundary plate moves with a certain velocity u in respect to a stationary two-dimensional boundary plate. In between the two boundary plates is present a fluid. The movement of the movable boundary plate causes the fluid to move. Two boundary conditions define the movement of the fluid. Directly at the stationary boundary plate, the fluid does not move at all, due to friction forces at the stationary boundary plate. Therefore, the velocity u is zero. Directly at the movable boundary plate, friction causes the fluid to move with the velocity u of the movable boundary plate.

In a simple model, the velocity u of the fluid increases linearly in a direction y measured from the stationary boundary plate. Thereby, a shear stress T is caused in the fluid, which depends on the distance between the two boundary plates, the viscosity of the fluid, and the absolute velocity of the moving boundary plate. The shear stress in the fluid results in a shear energy, which can be used as foaming energy, as used in the device of the present invention.

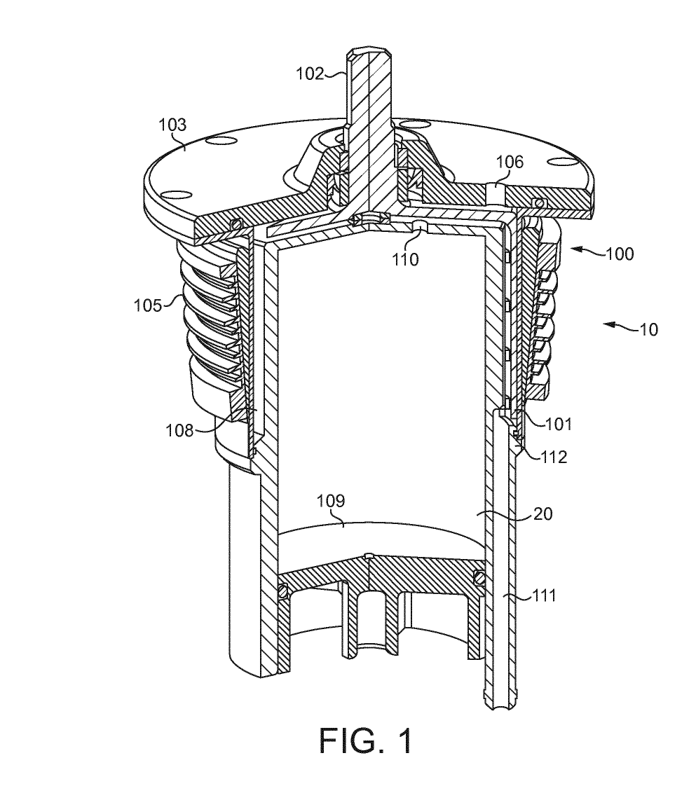

The cooling element 105 arranged external to the processing cover element 107 as shown in FIG. 1, is typically configured as a serpentine external cooling circuit through which a refrigerant fluid flows so as to cool the inner cooling walls 104 in contact with the fluid in the processing chamber 108. This is just an exemplary execution, and other possible ones would also be comprised within the scope of the invention.

As discussed previously, the device of the invention is able to provide different types of final products, frozen or cooled, which can further be aerated or not. Typically, the products to be delivered are ice-cream, a cooled or chilled liquid and foamed liquid. For the different products to be obtained, there are two variables to manage: to introduce or not air into the processing chamber 108 through the air entry 106 and the rotational speed of the processing element 101.

In the case of doing a cooled or chilled liquid, no air is introduced (the air entry 106 is therefore closed) and the processing element 101 is rotating at low speed, typically comprised in the range of 1 rpm to 10 rpm, allowing that the fluid is homogeneously mixed and cooled (as it is cooled by the inner cooling walls 104). The cooling element 105 is cooling down the fluid to a final temperature comprised between 5° C. and 0° C. before it is delivered through the product outlet 111. The scrapping edge 130 in the processing element 101 helps to take off the product on the inner cooling walls 104 into the whole fluid mixture, so as to homogeneously distribute cold within it.

In the case of preparing a foamed product (that can be chilled or not), air is introduced through the air entry 106 which is open and the processing element 101 rotates at a high speed, typically comprised between 1000 rpm and 3000 rpm. When cooled or chilled product is desired, the cooling element 105 cools the foamed fluid to a temperature typically comprised between 5° C. and 0° C. before it is delivered through the product outlet 111. The high speed of the processing element 101 is intended to properly mix and foam the fluid mixture: specifically, the disturbing elements 131 in the processing element 101 help to break fluid bubbles and incorporate air in the mixture, aerating it.

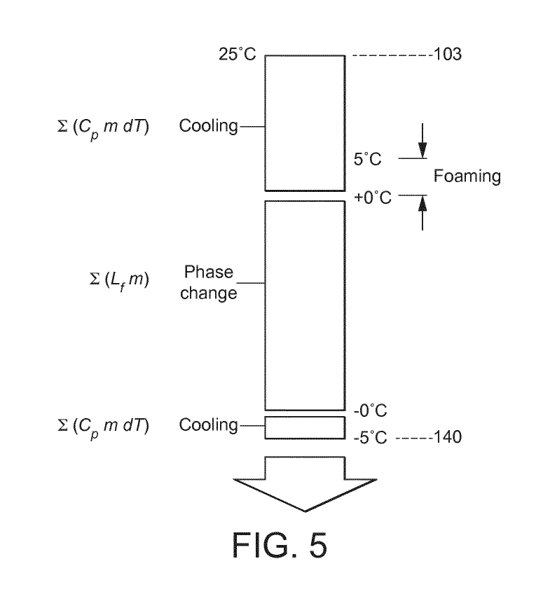

When preparing ice-cream with the device of the invention, the air entry 106 needs to be open (so air is incorporated in the fluid mixture) and the processing element 101 typically rotates at high speed, comprised between 1000 rpm and 3000 rpm. The cooling element 105 cools the fluid mixture to a temperature of typically −0° C. (see FIG. 5) to −5° C. to −10° C. before it is delivered through the product outlet 111. The scrapping edge 130 needs to scrap the frozen mixture adhering to the inner cooling walls 104 so as to incorporate it to the mixture in order to produce the ice-cream. Further, the mixture is aerated thanks to the disturbing elements 131 in the processing element 101 and thanks to the high rotational speed of the processing element 101.

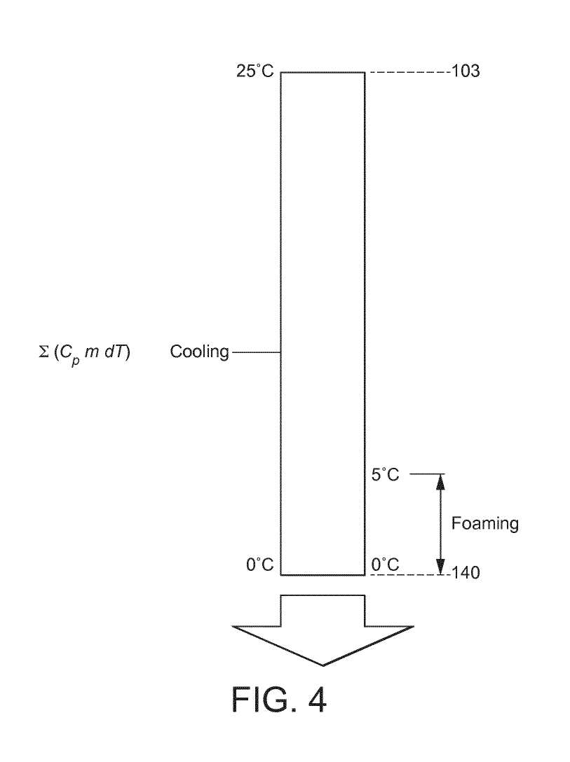

Referring now to FIG. 4, the theoretical energy path followed in a device according to the invention for a cooled aerated product is schematically represented, from the top of the processing chamber 103 to the bottom of the processing chamber 140 which connects with the product outlet 111. The fluid enters the processing chamber at ambient temperature, typically comprised between 20° C. and 25° C., is then cooled by contacting the inner cooling walls 104 and then distributed into the mixture thanks to the rotation of the processing element 101. Effective foaming of the mixture of fluid and air (air coming from the air entry 106) occurs at temperature comprised between 5° C. and 0° C., as shown in the graph of FIG. 4.

The energy balance, i.e. heat energy related to temperature difference for the fluid inside the processing chamber is given by:

Σ(C_{p m dT)}

where:

Cₚ is the specific heat capacity depending on the material

m is the mass of the product or ingredient

and

dT is the temperature difference (dT=T_{final}−Tᵢₙᵢₜᵢₐₗ)

The formula above gives heat energy transfer linked to the change of temperature of the product inside the processing chamber from ambient temperature into a lower temperature T₁ at the product outlet beverage outlet, typically comprised between 0° C. and 5° C.

Referring now to FIG. 5, the theoretical energy path followed in a device according to the invention for a frozen aerated product produced is schematically represented, from the top of the processing chamber 130 to the bottom of the processing chamber 140 which connects with the product outlet 111. The fluid enters the processing chamber at ambient temperature, typically comprised between 20° C. and 25° C., and is then cooled down to a temperature of +0° C. in aproximately 30% to 35% of the path of the processing chamber (in fact, efficient foaming takes place typically from 5° C. to +0° C., in approximately 5% to 10% of the path, as represented in FIG. 5). The energy balance, i.e. the heat energy related to the change of temperature of the product inside the processing chamber from ambient temperature into a lower temperature T₁ (+0° C.) after travelling a 30% to 35% of the total path of the processing chamber is given by:

Σ(Cₚ m dT)

where:

Cₚ is the specific heat capacity depending on the material

m is the mass of the product or ingredient

and

dT is the temperature difference (dT=T_{final}−Tᵢₙᵢₜᵢₐₗ)

Then, the product changes phase from liquid into solid, maintaining its temperature at around 0° C. (in fact, changing from +0° C. to −0° C.): it is estimated, as represented in FIG. 5, that aproximately 50% of the total mass of the product changes phase into solid and aproximately 50% to 60% of the total path of the processing chamber has been travelled.

The heat energy related to this phase change is give by:

Σ(L_{f}m)

where:

Lf is the latent heat depending on the material

and

m is the mass of the product or ingredient

Finally, the rest of 5% to 10% of the path of the processing chamber travelled by the product makes the product reduce its temperature further, from −0° C. to aproximately −5° C., until it is delivered as ice-cream product through the product outlet 111. The energy balance, i.e. heat energy related to temperature difference for the fluid inside this path of the processing chamber is given by:

Σ(Cₚ m dT)

where:

Cₚ is the specific heat capacity depending on the material

m is the mass of the product or ingredient

and

dT is the temperature difference (dT=T_{final}−Tᵢₙᵢₜᵢₐₗ)

The formula above gives heat energy transfer linked to the change of temperature of the product inside the processing chamber from −0° C. to −5° C., which is the final delivery temperature of the frozen product. Effective foaming of the mixture of fluid and air (air coming from the air entry 106) occurs at temperature comprised between 5° C. and +0° C., as shown in the graph of FIG. 5.

The main principle followed by a device according to the present invention is that, departing from a certain quantity of a certain product (fluid) inside the container 20, it is therefore known the total heat energy balance needed to change this fluid product at ambient temperature of depart into another product (cooled only or frozen, with the possibility of further being foamed). Further, the power of the cooling element 105 is known and so is the total volume cooled down in the path that the fluid will follow: departing from the upper part of the processing chamber 108 close to the upper cover 103 where the fluid outlets 110 are (therefore, from the point of entry of the product into the processing chamber) up to the lower part 140 of the processing chamber 108, which connects with the product outlet 111. Thus, it is in this volume that the product needs to pass through a certain energy transfer in order to achieve the desired cooling and possible phase change. The energy removal is provided by the cooling element 105.

Therefore, for a certain product to be achieved (frozen or chilled liquid), departing from known information (type of product in the container 20 and the power the cooling element 105 can provide) what is adjusted in the device of the invention is the flow rate of the product through the processing chamber 108, i.e. the residence time of the product passing into the processing chamber 108 must provide the final product desired. It is clear that this will be adjusted in a device as the one preferably described in the embodiments of the invention by means of adjusting the displacement velocity of the expelling means 109 into the container, which therefore provides the flow rate of the fluid in the processing chamber 108. Other characteristics of the final product will be given by the rotational speed of the processing element 101 (higher speed for ice-cream and foamed products and lower speed for cooled or chilled liquids) and by the air ratio introduced together with the fluid into the processing chamber (through the air entry 106).

Typically, the device of the invention works inline and provides the whole of the amount of the fluid in the container 20 into final product as a frozen, chilled and possibly foamed product delivered through the outlet 111. The container 20 provides a certain quantity of pre-defined product and is configured as a capsule, as a cartridge or the like.

The container 20 can also comprise identification means (not shown) with the information on the parameters to be used to prepare a cooled or frozen and possibly further aerated product, such as type of product to be produced in the device, temperature of the product to be delivered, processing time in the device, rotational speed of the processing element of the device, amongst others. Typically, the preparation machine 100 will comprise a processor configured to read the information on the identification means of the container 20 and execute the required parameters during the product preparation process.

According to a second aspect, the invention further relates to a method for preparing a cooled or frozen product, which can also be aerated, in a device as the one described above. The method of the invention comprises:
Inserting a container 20 comprising a food or beverage product into the preparation machine 100;
Displacing the expelling means 109 inside the container 20 at a certain velocity providing the flow rate needed of the fluid through the processing chamber 108, so as to deliver the content inside the container into the processing chamber 108 through the fluid outlet 110 at that certain flow rate;
Depending on the type of product to be made (aerated or not), possibly adding air through the air entry 106;
Depending on the type of product to be made, rotating at a certain speed the processing element 101 inside the processing chamber;
Simultaneously to the rotation of the processing element, the cooling element 105 is activated and refrigerates the inner cooling walls 104 contacting and cooling the product inside the processing chamber;
As explained previously, because the flow rate is a certain one defined so as to provide the fluid with a certain residence time in the processing chamber 108, the final prepared product is delivered through the product outlet 111.

Although the present invention has been described with reference to preferred embodiments thereof, many modifications and alterations may be made by a person having ordinary skill in the art without departing from the scope of this invention which is defined by the appended claims.

1. Device for preparing a cooled or frozen and/or foamed product, comprising:
a container where a certain quantity of a fluid at ambient temperature is stored;
an expeller configured to deliver a certain quantity of the fluid into a processing chamber at a certain flow rate;
a processing element rotatable within the processing chamber and configured to mix and/or scrap and/or foam the fluid in the processing chamber; and
a cooling element providing a certain cooling power configured to cool at least partially the processing chamber which is at least partially in contact with the fluid.

2. Device according to claim 1 wherein the speed of the expeller is calculated such that the flow rate of the fluid through the processing chamber allows that the cooling power provided by the cooling element cools the fluid to a desired temperature before the fluid leaves the processing chamber.

3. Device according to claim 1 wherein the rotational speed of the processing element depends on the type of cooled or frozen and/or foamed product to prepare.

4. Device according to claim 1 wherein the rotational speed of the processing element is in the range of 1 to 10 rpm to prepare a cooled or chilled product.

5. Device according to claim 1 wherein the rotational speed of the processing element is in the range of 1000 to 3000 rpm to prepare an ice-cream product or a foamed or aerated product.

6. Device according to claim 1, further comprising an air entry connected to the processing chamber, providing a certain air ratio into the chamber.

7. Device according to claim 6 wherein the value of the air ratio depends on the type of product to prepare, this ratio being zero when a cooled or chilled product is prepared, the ratio being different to zero when a foamed product or an ice-cream are prepared.

8. Device according to claim 1 wherein the processing chamber connects the fluid inlet from the expelled product coming from the container and a product outlet, so that the cooled or frozen and/or foamed product is delivered continuously.

9. Device according to claim 1 wherein the length of the processing chamber traversed by the fluid matches the cooling element.

10. Device according to claim 1 wherein the processing chamber configures a small gap in the radial direction, to allow high shear stress induced in the fluid by the processing element.

11. Device according to claim 1 wherein the processing chamber is configured by an outer cylinder and an inner cylinder concentrically arranged and forming a gap between them.

12. Device according to claim 2 wherein the gap configured between the cylinders is between 0.1 mm and 10 mm.

13. Device according to claim 1, wherein the processing element comprises at least a scrapping edge designed to scrap product adhering the inner walls of the processing chamber and one or a plurality of disturbing elements inducing foaming of the fluid by rotation of the processing element in the processing chamber by couette flow effect.

14. Device according to claim 1 wherein the container comprises an inner path to allow the expeller displace inside.

15. Device according to claim 1 comprising an identification member comprising process parameters allowing the preparation of a cooled or frozen and/or foamed product in the device.

16. Device according to claim 15 wherein the process parameters are selected from the group consisting of: type of product to be produced, temperature of the product delivered, flow rate of fluid in the processing chamber, rotational speed of the processing element, and air ratio to incorporate in the processing chamber.

17. Container comprising a certain quantity of a certain fluid at ambient temperature, configured to be used with a device for preparing a cooled or frozen and/or foamed product, comprising: an expeller configured to deliver a certain quantity of the fluid into a processing chamber at a certain flow rate; a processing element rotatable within the processing chamber and configured to mix and/or scrap and/or foam the fluid in the processing chamber; and a cooling element providing a certain cooling power configured to cool at least partially the processing chamber which is at least partially in contact with the fluid.

18. Container according to claim 17 comprising one part facing cooler and configuring a processing chamber where the cooled or frozen and/or foamed product is prepared.

19. Container according to claim 17 having an inner volume configured to cooperate with expeller displacing inside of it in order to expel at least part of its fluid content into the processing chamber in the device.

20. Method for preparing a cooled or frozen and/or foamed product, comprising:
inserting a container comprising a fluid at ambient temperature into a device;
displacing an expeller to deliver at least part of the fluid content of the container into a processing chamber at a certain flow rate, depending on the type of final product to deliver; and
rotating a processing member at a certain speed depending on the type of product to be finally delivered within the processing chamber and simultaneously cooling at least part of the processing chamber which is at least partly in contact with the product.

21. Method according to claim 20 wherein the rotational speed of the processing member varies depending on the product to be prepared, from a low speed in the range of 1 to 10 rpm to prepare a cooled or chilled product to a high speed in the range of 1000 to 3000 rpm to prepare an ice-cream product or a foamed or aerated product.

22. Method according to claim 20 wherein air is introduced into the processing chamber when aerated product is desired.

23-24. (canceled)
